(19) United States
(12) Patent Application Publication
(10) Pub. No.: US 2003/0019898 A1
(43) Pub. Date: Jan. 30, 2003

(54) Toilet paper holder

(76) Inventor: Yutaka Ito, Kamakura-shi (JP)

Correspondence Address: William Squire, Esq., Carella, Byrne, Bain, Gilfillan,, Cecchi, Stewart & Olstein, 6 Becker Farm Road, Roseland, NJ, 07068-1739, US

(21) Appl. No.: 10/186,543

(22) Filed: Jul. 1, 2002

(30) Foreign Application Priority Data
Jul. 3, 2001 (JP) 2001-239946

(51) Int. Cl. B26F 3/02

(52) U.S. Cl. 225/6

(57) ABSTRACT

A toilet paper holder, which can be handled by one hand, comprising a holder H for holding a rolled paper R, a paper holding shelf T monolithically formed at a bottom portion of the holder H for holding the downwardly drawn folded rolled paper R as being wound and a cutter for cutting the downwardly drawn paper R arranged between the holder H and the paper holding shelf T, can cut the downwardly drawn folded paper R on the paper holding shelf T by pulling the folded paper R forwardly.

### BACKGROUND OF THE INVENTION

1. Field of the Invention

The present invention relates to a toilet paper holder, which enables a user to handle by one hand.

2. Brief Description of the Related Art

In conventional toilet paper holders, both hands are required for winding and cutting toilet papers. In other words winding and cutting procedures are difficult for those who are handicapped in their right or left hands.

### SUMMARY OF THE INVENTION

The present invention is carried out in order to solve the above-mentioned problem in conventional toilet paper holders and to provide a toilet paper holder enable those who are handicapped in their one hands to wind and cut toilet papers by using their healthy other hands.

The toilet paper holder provided by the present invention comprises: a rolled paper holder, a shelf arranged below the rolled paper holder for folding and holding downwardly drawn rolled paper as being wound by one hand and a cutter arranged between the rolled paper holder and the shelf for cutting the folded rolled paper on the shelf when the folded rolled paper is forwardly pulled by one hand.

### BRIEF DESCRIPTION OF THE DRAWINGS

FIG. 1 is a front view of a toilet paper holder on the embodiment of the present invention.

FIG. 2 is a side view of the toilet paper holder shown in FIG. 1.

### DESCRIPTION OF THE PREFERRED EMBODIMENT

Hereinafter an embodiment of the present invention is explained by referring to the drawings.

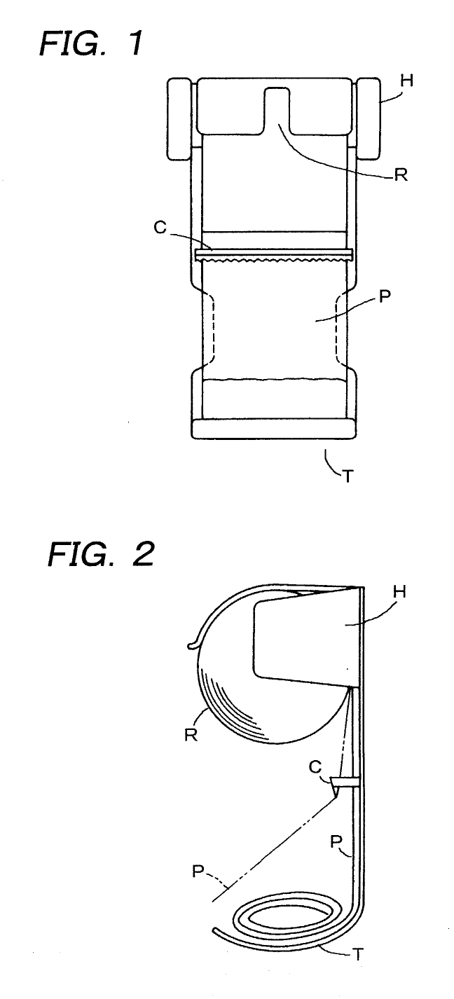

FIG. 1 is the front view of a toilet paper holder on the embodiment of the present invention.

FIG. 2 is the side view of the toilet paper holder shown in FIG. 1.

In these drawings, a reference character “H” is a holder holding a rolled paper R and a reference character “P” stands for downwardly drawn paper from the rolled paper R held in the holder H. A paper holding shelf T is monolithically formed at a bottom portion of the holder H. A cutter C for cutting the downwardly drawn paper P is arranged between the holder H and paper holding shelf T.

Hereinafter a series of procedures of the toilet paper holder of the present invention is explained. First of all, an end of the rolled paper R is downwardly drawn. The drawn paper P is folded as being wound by one hand after passing through behind the cutter C. The folded paper P is cut by the cutter C as the folded paper P being pulled forwardly, after a desired amount of the paper P is folded.

In the toilet paper holder of the present invention, the drawn and folded paper P is held by the paper holding shelf T so that it is not necessary to hold the folded paper P by one hand while the folded paper P is being cut by the other hand. The cut paper P can be stored on the paper holding shelf T for a while.

As mentioned above, a series of procedures comprising from the winding procedure to the cutting procedure can be performed by one hand in the toilet paper holder by the present invention. And the toilet paper holder can be arranged at a left side, at a right side or in front of a user and can be moved easily from one place to the other.

Elderly people with one handicapped hand owing to their aging, who feel inconvenience in the conventional toilet paper holders can use the toilet paper holder of the present invention more conveniently.

What is claimed is:

1. A toilet paper holder comprising:
a holder for holding a rolled paper;
a paper holding shelf monolithically formed at a bottom portion of said holder for holding the downwardly drawn folded rolled paper as being wound; and
a cutter for cutting the downwardly drawn paper arranged between said holder and said paper holding shelf, wherein:
the downwardly drawn folded paper on said paper holding shelf is cut by pulling the folded paper forwardly.

2. The toilet paper holder according to claim 1, wherein:
said toilet paper holder is constituted so as to perform a series of procedures comprising a procedure for drawing the rolled paper, a procedure for folding the drawn paper and a procedure for cutting the folded paper, by one hand.
